(19) United States
(12) Patent Application Publication
(10) Pub. No.: US 2026/0348922 A1
(43) Pub. Date: Nov. 5, 2026

(54) MIXER IN INJECTOR PATH FOR MIXING MOBILE PHASE

(71) Applicant: Agilent Technologies, Inc., Santa Clara, CA (US)

(72) Inventors: Thomas Ortmann, Straubenhardt/Ottenhausen (DE); Konstantin Shoykhet, Karlsruhe (DE)

(21) Appl. No.: 19/102,681

(22) PCT Filed: Aug. 12, 2022
(86) PCT No.: PCT/IB2022/057548

§ 371 Date: Feb. 10, 2025

(51) Int. Cl. G01N 30/20; B01D 15/14; B01F 25/432

(52) U.S. Cl. CPC G01N 30/20; B01D 15/14; B01F 25/4323; G01N 2030/201

(57) ABSTRACT

An injector, for injecting a fluidic sample from an injector path into a mobile phase for separation of the fluidic sample in a separation path of a sample separation apparatus, includes the injector path for accommodating mobile phase and fluidic sample, a fluidic valve switchable for selectively fluidically coupling or decoupling the injector path and the separation path, a sample accommodation volume in the injector path for accommodating the fluidic sample to be injected into the separation path, and a mixer in the injector path for mixing the mobile phase without mixing the fluidic sample when the injector path and the separation path are fluidically coupled by the fluidic valve.

### CROSS-REFERENCE TO RELATED APPLICATIONS

This application is the national stage under 35 U.S.C. 371 of International Application No. PCT/IB2022/0575458, filed on Aug. 12, 2022, the entire contents of which are incorporated by reference herein.

### TECHNICAL FIELD

The present disclosure relates to an injector, a sample separation apparatus, and a method of injecting a fluidic sample from an injector path of an injector into a mobile phase for separation of the fluidic sample in a separation path of a sample separation apparatus.

### BACKGROUND

In liquid chromatography, a fluidic sample and an eluent (liquid mobile phase) may be pumped through conduits and a separation unit such as a column in which separation of sample components takes place. The column may comprise a material which is capable of separating different components of the fluidic sample. The separation unit may be connected to other fluidic members (like a sampler or an injector, a detector) by conduits. Before the fluidic sample is introduced into a separation path between a fluid drive (in particular a high-pressure pump) and the separation unit, a predefined amount of fluidic sample shall be intaken from a sample source (such as a sample container) via an injection needle into a sample loop by a corresponding movement of a piston within a metering device. This usually occurs in the presence of a significantly smaller pressure than what the separation unit is run with. Thereafter, an injector valve is switched so as to introduce the intaken amount of fluidic sample from the sample loop of a metering path into the separation path between fluid drive and the separation unit for subsequent separation.

US 2021/215732 A1 discloses an automatic sample introduction device which includes a needle, a sample loop, a mixer and a suction injection switch mechanism. The mixer is provided between the needle and the sample loop. The suction injection switch mechanism sequentially sucks first and second fluids into the sample loop through the needle and the mixer and injects the first and second fluids held in the sample loop into a predetermined injection port. A chromatograph includes the automatic sample introduction device having the above-mentioned configuration, an analysis column and a detector. The analysis column is connected to the injection port of the automatic sample introduction device, and the detector is connected to the analysis column.

However conventional injectors may suffer from carryover of sample and may require a cumbersome purging mode.

### SUMMARY

There may be a need to provide an injector for a sample separation system as well as a sample separation system which can be operated quickly and accurately.

According to an exemplary embodiment of the present disclosure, an injector for injecting a fluidic sample from an injector path into a mobile phase for separation of the fluidic sample in a separation path of a sample separation apparatus is provided, wherein the injector comprises the injector path for accommodating mobile phase and fluidic sample, a fluidic valve (for instance in the injector path) being switchable for selectively fluidically coupling or decoupling the injector path and the separation path, a sample accommodation volume in the injector path for accommodating the fluidic sample to be injected into the separation path, and a mixer in the injector path for mixing the mobile phase without mixing the fluidic sample when the injector path and the separation path are fluidically coupled by the fluidic valve.

According to another exemplary embodiment, a sample separation apparatus for separating a fluidic sample is provided, wherein the sample separation apparatus comprises a fluid drive configured for driving a mobile phase and the fluidic sample, when injected in the mobile phase, along a separation path, an injector having the above-mentioned features and being configured for injecting the fluidic sample into the separation path, and a separation unit configured for separating the fluidic sample injected in the mobile phase in the separation path.

According to still another exemplary embodiment, a method of injecting a fluidic sample from an injector path of an injector into a mobile phase for separation of the fluidic sample in a separation path of a sample separation apparatus is provided, wherein the method comprises accommodating the fluidic sample to be injected into the separation path in a sample accommodation volume in the injector path, switching a fluidic valve (for instance in the injector path) for selectively fluidically coupling the injector path and the separation path, and mixing (in particular switchable inclusion of a mixing device for mixing) the mobile phase without mixing the fluidic sample by a mixer in the injector path when the injector path and the separation path are fluidically coupled by the fluidic valve.

In the context of the present application, the term “injector” may particularly denote a fluid processing member configured for intaking a fluidic sample and for subsequently injecting the intaken fluidic sample for separation in a separation path.

In the context of the present application, the term “fluid” may particularly denote a liquid and/or a gas, optionally comprising solid particles.

In the context of this application, the term “fluidic sample” may particularly denote any liquid and/or gaseous medium, optionally including also solid particles, which is to be separated. Such a fluidic sample may comprise a plurality of different molecules or particles which shall be separated, for instance small mass molecules or large mass biomolecules such as proteins. Separation of a fluidic sample may involve a certain separation criterion (such as mass, volume, chemical properties, etc.) according to which a separation is carried out.

In the context of this application, the term “mobile phase” may particularly denote any liquid and/or gaseous medium which may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample which have very different affinity to a stationary phase of a sample separation unit.

In the context of the present application, the term “separation path” may particularly denote a fluidic path between a fluid drive and a separation unit along which a mobile phase may flow. Also, fluidic sample can be moved inside of or together with a mobile phase along the separation path for separation of the fluidic sample at the separation unit.

In the context of the present application, the term “sample separation apparatus” may particularly denote an apparatus which is configured for separating a fluidic sample into different fractions. In particular, the sample separation apparatus may be a chromatography apparatus. When the fluidic sample is applied to the sample separation apparatus and is injected via the injector into the separation path between fluid drive and sample separation unit, different physical, chemical and/or biological properties of different fractions of the fluidic sample may result in a separation of the different fractions on their way along the separation path and specifically within the sample separation unit.

In the context of the present application, the term “injector path” may particularly denote a fluidic path inside of the injector which can be selectively fluidically decoupled from the separation path (for instance for intaking fluidic sample into the injector path) or which can be fluidically coupled with the separation path (for example for injecting fluidic sample from the injector path into the separation path).

In the context of the present application, the term “fluidic valve” may particularly denote a member for dispatching or directing or preventing a fluidic flow (in particular automatically or in a controlled way) through or into a specific flow path or conduit. For example, a fluidic valve may be a member for processing fluid functioning (in particular automatically or in a controlled way) for controlling a fluid flow through the fluidic valve. For instance, the fluidic valve may be closed to disable fluid flow through the fluidic valve and a respective connected fluidic path, or may be opened to enable fluid flow through the fluidic valve and a respective connected fluidic path. It is also possible that a fluidic valve is partially openable to different extent to enable a limited fluid flow through the fluidic valve and a respective connected fluidic path to a selectable extent. For example, the fluidic valve may comprise a stator comprising a plurality of fluid ports (for fluid coupling with fluid processing members) and may comprise a rotor comprising at least one conduit (such as a groove), wherein rotation of the rotor with respect to the stator may selectively fluidically couple or decouple a respective conduit with respect to the fluid ports. Alternatively, a fluidic valve may also establish different fluid connection states by a translatory relative motion of different valve bodies.

In the context of the present application, the term “sample accommodation volume” may particularly denote an entity configured for temporarily accommodating a predefined amount of fluidic sample for subsequent processing, for instance for subsequent separation. For example, such a sample accommodation volume may be a sample loop (for instance a helically wound conduit) or a trap column.

In the context of the present application, the term “mixer” may particularly denote a fluidic member capable of promoting interaction between fluid portions to enhance homogeneity of the fluid mixture. Mixing may be performed by various ways, for instance by at least partly changing an order of fluid packets in a sequence of fluid packets, and/or by generating motion, particularly turbulences, in fluids so that different portions of the fluid are brought in interaction for a more homogeneous distribution of the fluid sections. For instance, the mixer may be a longitudinal mixer which is capable of performing the enhancement of the interaction of different fluid sections or the change of the order of certain fluid sections in a direction along the flow path, i.e. along the lumen of a fluidic conduit rather than only perpendicular thereto. The mixing performance of such a longitudinal mixer may therefore be anisotropic with the flow direction forming the preferred direction.

In the context of the present application, the term “mixing the mobile phase without mixing the fluidic sample” may particularly denote a mixing performance resulting from a control of the injector so that only mobile phase, but no fluidic sample from the injector path, passes the mixer and is thereby subjected to mixing. In particular, mixing the mobile phase without mixing the fluidic sample may be accomplished by controlling an operation of the mixer during injecting a fluidic sample from the injector path into the separation path using a mobile phase as a conveying medium for the fluidic sample so that only mobile phase but no fluidic sample can enter or be processed by the mixer and be thereby mixed by the mixer.

In the context of the present application, the term “fluid drive” may particularly denote an entity capable of driving a fluid, in particular the fluidic sample and/or the mobile phase. For instance, the fluid drive may be a pump (for instance embodied as piston pump or peristaltic pump) or another source of pressure and/or fluidic flow. For instance, the fluid drive may be a high-pressure pump, for example capable of driving a fluid with a pressure of at least 100 bar, in particular at least 1000 bar. The fluid drive may function as analytical pump during chromatographic sample separation.

The term “separation unit” may particularly denote a fluidic member through which a fluidic sample is transferred, and which is configured so that, upon conducting the fluidic sample through the separation unit, the fluidic sample will be separated into different groups of molecules or particles. An example for a separation unit is a chromatographic column which is capable of trapping or retarding and selectively releasing different fractions of the fluidic sample. In particular, a sample separation unit may be a tubular body.

According to an exemplary embodiment, a fluid mixer is arranged in an injector path of an injector for injecting a fluidic sample into a mobile phase for sample separation in such a way that the mixer will only mix the mobile phase but not the fluidic sample. For this purpose, a control unit (or the like) may be provided for switching a fluidic valve (for instance in the injector path) between different operation states in which the injector path and a separation path (in which the fluidic sample is separated) are selectively fluidically coupled with each other or fluidically decoupled from each other. When coupling the injector path with the separation path for sample injection, mobile phase (in particular provided by a fluid drive) may be driven through the mixer before conveying, downstream of the mixer, fluidic sample from a sample accommodation volume towards a separation unit for sample separation. By arranging the mixer in the injector path (rather than in the separation path apart from the injector path) it may be possible to selectively switch the mixer out of the separation path, for instance for purging the separation unit with a purging fluid without involving the mixer (which may have a considerable interior volume). This may simplify construction of a sample separation apparatus and may save time and solvent during reconditioning and purging the separation unit and other components of the separation system. By ensuring that the mixer will mix only mobile phase (for example for damping undesired properties variations in the mobile phase, for instance composed of different solvents, provided by the fluid drive), any undesired impact of the fluidic sample on the mixer and on the sample separation apparatus as a whole (for instance carryover issues) may be reliably prevented. Thus, by keeping the fluidic sample out of the mixer, no issues concerning carryover occur. Also, keeping the fluidic sample out of the mixer prevents undesired broadening of the fluidic sample zone (aka sample plug) in the separation path, Hence, an injector according to an exemplary embodiment may be operated quick and accurately.

In the following, further embodiments of the injector, the sample separation apparatus, and the method will be explained.

In an embodiment, the injector (in particular its fluidic valve and a control unit for controlling the latter, as well as a metering device and its control by a control unit) is configured to be operable so that fluidic sample does not flow through the mixer neither during intaking fluidic sample into the sample accommodation volume nor during transferring fluidic sample from the sample accommodation volume into the separation path. During intaking fluidic sample, the fluid flow direction within the injector path may be inverse to a fluid flow direction during transferring fluidic sample from the injector path into the separation path. In both directions, no sample will flow through the mixer. By correspondingly switching the fluidic valve, in particular under control of a control unit, into an injection state in which separation path and injector path are fluidically coupled, any contact between the mixer and the fluidic sample may be prevented during sample injection. By operating the metering device accordingly, in particular under control of the same or another control unit, contact between the mixer and the fluidic sample may be prevented during sample intake. This may reliably prevent carryover of fluidic sample between different separation runs and sample plug broadening.

In an embodiment, the injector (in particular its fluidic valve and a control unit for controlling the latter, as well as a metering device and its control by a control unit) is configured to be operable so that fluidic sample never gets into contact with the mixer. Advantageously, control of the sample separation apparatus and in particular the injector by a control unit may ensure that in no operation state (in particular during sample intake, during sample injection, during purging) fluidic sample gets into contact with the mixer. More specifically, the control may be executed so that only mobile phase gets into contact with the mixer in any operation state of the injector and in particular of the sample separation apparatus.

In an embodiment, the injector comprises a metering device operable for intaking a metered amount of fluidic sample in the sample accommodation volume. For instance, the metering device may comprise a piston pump or a syringe pump. The metering device may be configured for withdrawing a piston for drawing fluidic sample into the sample accommodation volume. Optionally, the piston may be moved forwardly for injecting the drawn fluidic sample into the separation path. Switching of the fluidic valve and operation of the metering device may be synchronized or coordinated by a control unit. When the metering device's piston is withdrawn for intaking fluidic sample into the sample separation volume, a control unit controlling the operation may ensure that the piston is not withdrawn up to such a position that fluidic sample may get in contact with the mixer.

In an embodiment, the metering device is arranged in the injector path between the sample accommodation volume and the mixer. This geometric arrangement may render it advantageously impossible that fluidic sample reaches the mixer when loading sample into the sample accommodation volume by a withdrawing motion of a piston of the metering device.

In an embodiment, the injector comprises a control unit configured for controlling the metering device for pre-compressing at least part of the injector path (in particular the sample accommodation volume loaded with fluidic sample) before injecting the fluidic sample from the injector path into the separation path. The sample separation system may thus be configured for pre-compressing the fluidic sample (which may be intaken initially at ambient pressure) in the sample accommodation volume by a corresponding operation of the metering device before injecting the pre-compressed fluidic sample into the separation path (which may be at a high-pressure level, for instance 1200 bar). In a corresponding way, the sample separation apparatus may be configured for decompressing the sample accommodation volume after injecting fluidic sample from the sample accommodation volume (which may still be at system pressure) into the separation path and before accommodating further fluidic sample in the sample accommodation volume (for example again at ambient pressure). Such a pre-compression and/or decompression functionality may avoid abrupt pressure shocks between injector path and separation path. This may reduce wear-out and may extend the lifetime of the injector and the sample separation apparatus as a whole.

In an embodiment, the injector comprises a sample needle and a needle seat, wherein the sample needle is movable out of the needle seat for intaking fluidic sample through the sample needle into the sample accommodation volume, and wherein the sample needle is movable into the needle seat for injecting intaken fluidic sample into the separation path by switching the fluidic valve. More specifically, the needle may be configured to be movable out of the needle seat and into a sample container for transferring fluidic sample from the sample container to the sample accommodation volume, for instance by moving a piston of a metering device in a backward direction. Moreover, the sample needle may be drivable back into the needle seat for establishing a fluid-tight connection between needle and seat and for injecting the transferred fluidic sample from the sample accommodation volume into the separation path, for instance by the driving force of mobile phase driven by the drive unit and/or by moving a piston of a metering device in a forward direction.

In an embodiment, the mixer is arranged apart from a section between the sample needle and the sample accommodation volume. Thus, the mixer may be not arranged between the sample needle and the sample accommodation volume. By locating the mixer apart from a fluidic conduit between sample needle and sample accommodation volume, it may be ensured that no fluidic sample gets into direct physical contact with the mixer during intaking fluidic sample from a sample reservoir into the sample accommodation volume through the needle.

In particular, at least one of the following embodiments may be possible: In an embodiment having a fixed loop injector, for example in a sample intake state of the sampler or injector, the mixer may be fluidically disconnected from the sample intake flow path (i.e. it can be entirely disconnected or involved into the separation flow path). In another embodiment, the mixer is fluidically connected to the sample intake flow path such that the mixer is connected flow downstream (with respect to the direction of the flow in the sample intake flow path during sample intake) to the sample intake port (for example needle) and the sample accommodation volume. In an embodiment, the mixer may, in the sample introduction or separation state of the sampler or injector, be included into the sample separation path flow upstream to the sample accommodation unit (with respect to the direction of the flow in the sample separation path). In an embodiment, the mixer may, in the sample introduction or separation state of the sampler or injector, be configured to be switchable out of the sample separation path.

In an embodiment, the fluidic valve is configured to be operable so that the mixer is selectively switchable out of a flow path along which mobile phase flows. In particular, the fluidic valve may be configured to be operable so that the mixer can be (for instance temporarily) bypassed with regard to a flow of mobile phase when the injector path and the separation path are fluidically coupled by the fluidic valve. In one scenario, it may be intended that the mixer is fluidically coupled within a flow path along which mobile phase flows when injecting fluidic sample into the separation path by connecting the injector path with the separator path by a corresponding switching of the fluidic valve. This may be intended for an application or an operation phase in which it is desired that the mobile phase being delivered from the fluid drive to the injector path for moving the fluidic sample towards a separation unit shall have a highly homogeneous solvent composition. Guiding the mobile phase through the injector in the injector path may then promote mixing and thereby homogenization of the mobile phase when passing the mixer. However, for other applications or another operation phase, it may not be necessary or desired that the mobile phase delivered from the fluid drive to the injector path for moving the fluidic sample towards a separation unit is additionally homogenized by the mixer. In the latter mentioned scenario, it may be more important to keep the total volume of fluidic members in a flow path small, for instance during a separation run or during purging (for instance of part of the injector path). Highly advantageously, the described embodiment may then make it possible to switch (for instance selectively, temporarily and/or reversibly) the mixer in the injector path out of a flow path (which may include part of the injector path, and optionally at least part of the separation path) through which mobile phase flows. To put it shortly, the described embodiment may make it possible to selectively engage or disengage the mixer in a flow path of the sample separation apparatus through which mobile phase flows. This increases the flexibility of operating the injector and the sample separation apparatus as a whole in line with the requirements of a certain application of operation phase.

In an embodiment, the fluidic valve is configured to be operable so that a metering device for intaking a metered amount of fluidic sample into the sample accommodation volume is bypassed with regard to a flow of mobile phase when the injector path and the separation path are fluidically coupled by the fluidic valve. By providing the option to selectively disengage the metering device from a flow path through which mobile phase flows during sample separation, the number and total volume of fluidic members in a flow path may be further reduced. This may accelerate operation of the sample separation apparatus and may exclude temporarily non-required fluidic members. The possibility of disengaging a metering device from a flow path, for instance achieved by a corresponding design and switching logic of the fluidic valve, may be implemented in order to be able to switch at least one fluidic member (such as a filter) out or on from the path between pump and column via the injection valve.

In an embodiment, the fluidic valve is configured to be operable so that both the mixer and a metering device for intaking a metered amount of fluidic sample into the sample accommodation volume are bypassed with regard to a flow of mobile phase when the injector path and the separation path are fluidically coupled by the fluidic valve. In such an embodiment, both metering device and mixer may be selectively switched into a flow path or out of a flow path to make it possible that, depending on the needs of a specific application or operation phase, metering device and mixer are engaged or disengaged. This option may further improve flexibility of operating the injector and the sample separation apparatus as a whole.

In embodiments, the mixer is a passive mixer or is an active mixer. While an active mixer may require active control or supply of electric drive power for carrying out a mixing task, a passive mixer may mix a mobile phase driven through it without active control or the supply of electric drive power. When being embodied as an active mixer, the mixer may for example comprise a stirrer in a mixing volume for stirring the mobile phase to enhance homogenization. An active mixer may create turbulence in the mobile phase and may thereby efficiently mix different constituents of the mobile phase. For example, a passive mixer may be a ball mixer (i.e. a mixer guiding mobile phase to be mixed through a mixing volume (such as a tube) being filled with a plurality of small balls). Another embodiment of a passive mixer is a helical tube or conduit through which the mobile phase to be mixed is guided.

In an embodiment, the mixer is adapted for splitting the mobile phase supplied at a mixer inlet into a plurality of fluid paths with different internal fluid flow delay characteristics and is adapted for combining the fluid paths at one or a plurality of rejoining points to thereby mix the mobile phase in a longitudinal fashion. Splitting a mobile phase to be mixed into hydraulically parallel channels with designed transition time values for a respective fluid portion and by combining the fluid portions again after they have passed the respective channel allows for a simple and efficient mixing without the necessity of actively controlling such a mixer.

In an embodiment, the mixer is configured for mixing the mobile phase for at least partially smoothing composition instabilities of the mobile phase. When a mobile phase is constituted as a composition of two or more different solvents (for example water and an organic solvent, such as methanol), a proportioning unit may proportion fluid portions of the solvents and may supply such fluid portions to a fluid drive (such as a piston pump, or an arrangement of serially and/or parallel coupled piston pumps) for compression. While the reciprocation of the one or more pistons may cause a certain amount of mixing of the mobile phase, some composition instabilities may remain at the outlet of the drive unit. Stability of a mobile phase flow and its composition may be of utmost importance for accuracy and reliability as well as reproducibility of a separation result, for instance a chromatographic separation result (such as a chromatogram). Thus, providing a mixer in the injector path and thereby relatively close to a separation unit may ensure a high accuracy and reproducibility of a separation result by smoothing composition instabilities of the mobile phase by mixing.

In an embodiment, the injector comprises a purging device operable for purging at least part of the separation path, in particular a separation unit in the separation path, with a purging fluid without purging the mixer with the purging fluid. For instance, the purging device may be a flush pump or the fluid drive for providing mobile phase for purging the separation path, in particular a separation unit in the separation path. Purging a separation unit (such as a chromatographic column) may be carried out after a separation run for reconditioning and cleaning the separation unit. For this purpose, a purging device may be provided, for instance a purge pump for pumping a mobile phase through the separation unit for purging. By implementing a mixer in the injector path rather than in the separation path, purging of the separation path without the mixer may be accomplished, which saves time and solvent for purging. Since a mixer may have a considerable interior volume, arranging the mixer outside of a separation path may reduce the volume to be purged.

In an embodiment, the sample separation apparatus comprises a further mixer arranged upstream of the injector in the separation path. Such a further mixer may be located in particular upstream (as a low-pressure mixer) or downstream (as a high-pressure mixer) of the fluid drive. Optionally, the sample separation apparatus may comprise one or more further mixers in addition to the at least one mixer in the injector path. The additional at least one mixer in the separation path may be arranged in addition to the fluid drive which, for instance when embodied as piston pump or sequence of piston pumps, may also provide some mixing effect. By providing at least one additional mixer in the separation path, the mixing performance and therefore the homogeneity of the mobile phase may be further enhanced. For example, such at least one additional mixer (for mixing different solvents to provide a more homogeneous mobile phase) may be applied before or shortly after the fluid drive (in particular a high-pressure pump). Alternatively, the at least one mixer in the injector path may be the only mixer or mixers of the sample separation apparatus with its fluid drive.

Embodiments of the above-described valve arrangement may be implemented in conventionally available HPLC systems, such as the Agilent 1200 Series Rapid Resolution LC system or the Agilent 1290 HPLC series (both provided by the applicant Agilent Technologies see the website www.agilent.com).

One embodiment of a sample separation apparatus, in which one or more of the above-described fluidic valves may be implemented, comprises a pumping apparatus as fluid drive or mobile phase drive having a pump piston for reciprocation in a pump working chamber to compress liquid in the pump working chamber to a high pressure at which compressibility of the liquid becomes noticeable. This pumping apparatus may be configured to know (by means of operator's input, notification from another module of the instrument or similar) or elsewise derive solvent properties, which may be used to represent or retrieve actual properties of fluidic content, which is anticipated to be in a sampling apparatus.

The separation unit of the sample separation apparatus may comprise a chromatographic column (see for instance the web page en.wikipedia.org/wiki/Column_chromatography) providing the stationary phase. The column may be a glass or steel tube (for instance, with a diameter from 50 μm to 5 mm and a length of 1 cm to 1 m) or a microfluidic column (as disclosed for instance in EP 1577012 or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, or surface-modified silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface.

The mobile phase (or eluent) can be a pure solvent or a mixture of different solvents (such as water and an organic solvent such as ACN, acetonitrile). It can be chosen for instance to minimize the retention of the compounds of interest and/or the amount of mobile phase to run the chromatography. The mobile phase can also be chosen so that the different compounds or fractions of the fluidic sample can be separated effectively. The mobile phase may comprise an organic solvent like for instance methanol or acetonitrile, often diluted with water. For gradient operation, water and organic solvent are delivered in separate bottles, from which the gradient pump delivers a programmed blend to the system. Other commonly used solvents may be isopropanol, tetrahydrofuran (THF), hexane, ethanol and/or any combination thereof or any combination of these with aforementioned solvents.

The fluidic sample may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 10-150 MPa (150 to 1500 bar), and more particularly 50-120 MPa (500 to 1200 bar).

The sample separation apparatus, for instance an HPLC system, may further comprise a detector for detecting separated compounds of the fluidic sample, a fractionating unit for outputting separated compounds of the fluidic sample, or any combination thereof. Further details of such an HPLC system are disclosed with respect to the Agilent 1200 Series Rapid Resolution LC system or the Agilent 1150 HPLC series, both provided by the applicant Agilent Technologies, at the website www. agilent. com.

Embodiments of the present disclosure may be partly or entirely embodied or supported by one or more suitable software programs, which can be stored on or otherwise provided by any kind of non-transitory medium or data carrier, and which may be executed in or by any suitable data processing unit such as an electronic processor-based computing device (or system controller, controller, control unit, device for data processing, etc.) that includes one or more electronic processors and memories. Software programs or routines may be applied in or by the control unit, e.g., a data processing system such as a computer, such as for executing any of the methods described herein.

### BRIEF DESCRIPTION OF THE DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 shows a sample separation apparatus in accordance with embodiments of the present disclosure, particularly used in high-performance liquid chromatography (HPLC).

FIG. 2 illustrates an injector in sample loading and precompression/decompression modes of operation, according to an exemplary embodiment of the present disclosure.

FIG. 3 illustrates the injector shown in FIG. 2 in a sample injection mode of operation, according to an exemplary embodiment of the present disclosure.

FIG. 4 illustrates the injector shown in FIG. 2 in a purge mode of operation, according to an exemplary embodiment of the present disclosure.

FIG. 5 illustrates an injector in an operational mode in which a metering device and one or more mixers are switched into a flow path, according to another exemplary embodiment of the present disclosure.

FIG. 6 illustrates the injector of FIG. 5 in an operational mode in which the metering device and one or more of the mixers are switched out of the flow path, according to another exemplary embodiment of the present disclosure.

FIG. 7 illustrates a mixer for an injector according to another exemplary embodiment of the present disclosure.

FIG. 8 illustrates an injector in a sample injection mode of operation, according to still another exemplary embodiment of the present disclosure with a fixed loop.

FIG. 9 illustrates the injector of FIG. 8 in a sample injection mode of operation, according to an exemplary embodiment of the present disclosure.

FIG. 10 illustrates the injector of FIG. 8 in a mode of operation in which a separation path bypasses a mixer and a sample accommodation volume, according to an exemplary embodiment of the present disclosure.

The illustrations in the drawings are schematic.

### DETAILED DESCRIPTION

Before describing the drawing figures in further detail, some basic considerations of the present disclosure will be summarized based on which exemplary embodiments have been developed.

In HPLC applications, it may be beneficial or necessary to smooth down composition instabilities in an eluent flow generated by an analytical pump. This can be done by adding a mixer into the separation path in the pump or immediately downstream of the pump. Downsides of such an approach are prolonged system equilibration times, especially after large composition changes. Conventionally, supply of fluid during a gradient run and during reconditioning of a chromatographic separation column may be done through a mixer arranged in a separation path. However, such an approach is time consuming and wastes solvent.

According to an exemplary embodiment of the present disclosure, an injector (or sampler) for injecting a fluidic sample (i.e. a sample which shall be separated, for instance into different fractions) into a mobile phase (such as a solvent composition) in a separation path of a sample separation apparatus (for example a chromatographic separation apparatus, such as a liquid chromatography apparatus or an HPLC apparatus) is provided. An injector path allows to accommodate a fluidic sample in a sample accommodation volume (such as a sample loop) as well as mobile phase in fluid conduits. A fluidic valve in the injector path may be switched, controlled by a control unit (which may control operation of the injector or the sample separation apparatus as a whole), to fluidically decouple the injector path from the separation path (for instance for loading or intaking fluidic sample into the sample accommodation volume, or for purging a separation unit (such as a chromatographic column) in the separation path). The fluidic valve may also be controlled by the control unit for fluidically coupling the separation path with the injector path, in particular for injecting fluidic sample from the sample accommodation volume in the separation path for separation (for instance for executing a gradient run or an isocratic separation run). Advantageously, at least one mixer may be implemented in the injector path for mixing the mobile phase but not the fluidic sample before and during a separation run. By arranging the one or more mixers, which may be operated for mobile phase mixing only, in the injector path, purging of the separation unit in the separation path may be carried out without the mixer. Consequently, it may be prevented that the mixer acts as a fluidic load during such a purging operation, which saves time and solvent during purging. By implementing the mixer and controlling the injector so that fluidic sample is prevented from being mixed by the mixer and only mobile phase is subjected to mixing by the mixer, undesired carryover of fluidic sample between different separation runs may be reliably avoided.

Hence, an exemplary embodiment of the present disclosure provides a mixer in a sampling path of an injector. In other words, a sampling path or injector path may be equipped with one or more mixing devices according to exemplary embodiments. More specifically, an exemplary embodiment provides a sample separation apparatus which may be embodied as an HPLC instrument having an injector for introducing a fluidic sample into the mobile phase. This may be accomplished by coupling a sampling or injector path (being provided separately from a separation path) to the high-pressure separation path of the mobile phase (between fluid drive, for instance pump, and separation unit, for example chromatographic separation column). Advantageously, the mixer may be located in the sampling or injector path, which allows to decouple the mixer from the high-pressure path without requiring an additional valve. Furthermore, such a mixer in an injector path has the advantage that it may be removable from the separation path or even from any flow path used for conducting mobile phase.

Thus, an exemplary embodiment of the present disclosure provides a mixer at a position within the sampling or injector path which will not be reached by the fluidic sample when introduced into the sample accommodation volume (such as a sample loop). In other words, the mixer may be arranged, operated and/or controlled so that this mixer is not used for mixing the fluidic sample during or after intaking of the fluidic sample and during injection into the mobile phase.

Further advantageously, the injection valve may be configured for allowing to couple and/or decouple the mixer into and/or from the sampling path. In an application or operation phase in which no mixer is required for mixing mobile phase (for example since presently there are no demanding requirements in terms of homogeneity of the mobile phase) this may allow to switch the mixer out of a flow path for mixing mobile phase. If however in another application or operation phase, a pronounced or an enhanced homogeneity of the mobile phase is desired, the mixer may be switched into the flow path for mixing the mobile phase. This increases the flexibility of using the injector for different purposes and tasks.

Arranging the mixer in the injector path (rather than in the separation path) provides the injector or the separation apparatus with the ability to purge the separation unit (such as a separation column) without purging the mixer. This may lead to a reduced purging volume and to a reduced purging time. When executing pre-compression of the injector path (which may be at ambient pressure during intaking sample into its sample accommodation volume) prior to its fluidic coupling with the separation path (which may be at system pressure of for example 1500 bar), a pressure dip upon switching may be prevented or at least reduced. Pre-compression of the injector path may be carried out, for example, by a metering device for metering fluidic sample to be loaded into the sample accommodation volume, by the fluid drive driving mobile phase towards the separation unit and/or by a further pressure source (such as a further pump).

In particular, an exemplary embodiment of the present disclosure provides a mixer in the part of the sampling or injector path, which can be dynamically switched out of the flow path. By correspondingly operating a fluidic valve, the mixer can be bypassed during operation phases in which composition ripples in the solvents due to incomplete mixing are tolerable and the eluent composition strongly differs from that needed during the separation. If however an additional mixing of such a mobile phase is desired, the mixer can be switched into the active flow path through which mobile phase is flowing.

For example, in many bio-pharma applications it is common to run a flat composition gradient (for example such that the gradient start and end compositions differ only by a few percent, for example a gradient from 30% to 32% of a solvent B) for separation in order to achieve necessary chromatographic resolution. Furthermore, such applications may add a flush-out stage with high eluent strength (for example 80% of solvent B) afterwards, in view of analytically irrelevant sample components and contaminants with stronger retention, which otherwise may remain uneluted (or not eluted) at the column. It is clear that, once the separation requires such a flat gradient, it may be desired that the initial condition is also held very precise.

On the other hand, solvent composition at the mixer outlet approaches the target value asymptotically over time. For example in an approximation, the difference between the actual mixer outlet composition and the target composition can decrease exponentially with for example a certain time constant or half-life time.

The chromatographic application may demand that the mixer outlet composition differs from the programmed composition value by, for example, not more than 0.05 %. If the half-life time under given conditions is for example 0.5 min, then the restoration of the 30% composition at the mixer outlet would take about 2.7 min after the mixer has been filled with 32%-composition. In the case that the mixer has been filled with 80%-composition, the restoration of the 30%-composition would already take 5.4 minutes. Thus, it may be advantageous to avoid filling the mixer with 80% composition at all. This does not only save time and solvent for flushing the mixer up and down, but may, even more pronouncedly, save time needed for re-establishing the initial condition after an HPLC separation.

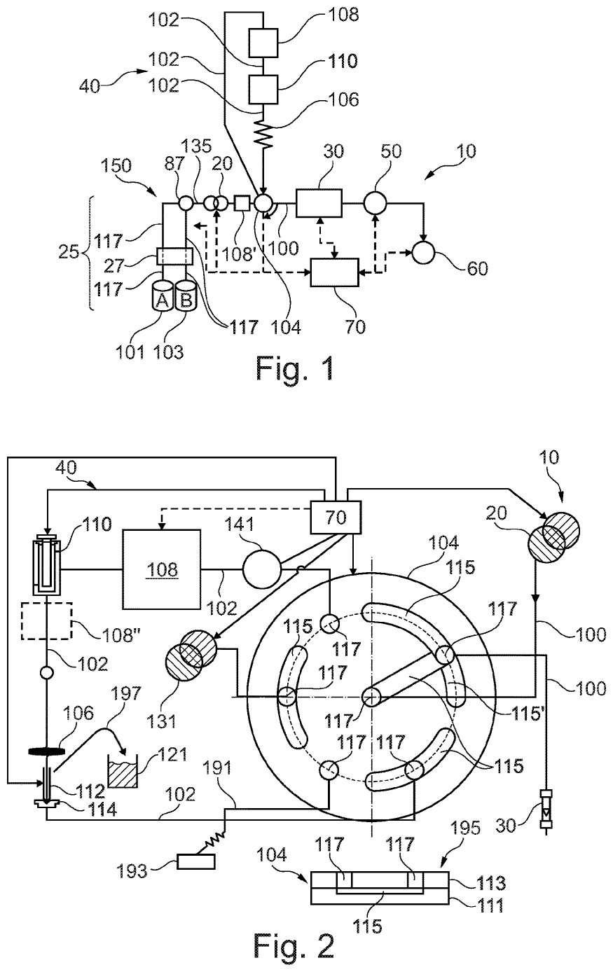

Referring now in greater detail to the drawings, FIG. 1 depicts a general schematic of a liquid separation system as an example for a sample separation apparatus 10 according to an exemplary embodiment of the present disclosure. A pump, as fluid drive 20, receives a mobile phase from a solvent supply 25, typically via a degasser 27, which degases and thus reduces the amount of dissolved gases in the mobile phase. The mobile phase drive or fluid drive 20 drives the mobile phase through a separation unit 30 (such as a chromatographic column) comprising a stationary phase. A sampler or injector 40, implementing a single fluidic valve 104 (or a valve arrangement comprising a plurality of cooperating fluidic valves), can be provided between the fluid drive 20 and the separation unit 30 in order to subject or add (often referred to as sample introduction) a fluidic sample into the mobile phase. The stationary phase of the separation unit 30 is configured for separating compounds of the sample liquid. A detector 50 is provided for detecting separated compounds of the fluidic sample. A fractionating unit 60 can be provided for outputting separated compounds of fluidic sample.

While the mobile phase can be comprised of one solvent only, it may also be mixed from plural solvents. Such mixing may be accomplished as a low pressure mixing and provided upstream of the fluid drive 20, so that the fluid drive 20 already receives and pumps the mixed solvents as the mobile phase. Alternatively, the fluid drive 20 may be comprised of plural individual pumping units, with the pumping units each receiving and pumping a different solvent or mixture, so that the mixing of the mobile phase (as received by the separation unit 30) occurs at high pressure and downstream of the fluid drive 20 (or as part thereof). This is shown in FIG. 1 in the form of optional mixer 108′ arranged in a separation path 100 between fluid drive 20 and separation unit 30. Hence, the optional additional mixer 108′ may be located directly upstream (as a low-pressure mixer) or directly downstream (as a high-pressure mixer) of fluid drive 20 and upstream of injector 40.

The composition (mixture) of the mobile phase may be kept constant over time, the so-called isocratic mode, or varied over time, the so-called gradient mode.

FIG. 1 also shows a liquid supply system 150 configured for metering liquids in controlled proportions and for supplying a resultant mixture. The liquid supply system 150 comprises (in the shown embodiment) two reservoirs 101, 103, with each of the reservoirs 101, 103 containing a respective solvent A (in this example water), B (in this example a buffer, i.e. salt dissolved in a solvent). Moreover, it is possible to provide one or more additional reservoirs, for instance an additional reservoir comprising an organic solvent, a further reservoir comprising an optional organic modifier, etc. Each of the reservoirs 101, 103 is fluidically connected via a respective liquid supply line 117 with a proportioning unit 87 which may be configured as proportioning valve. The proportioning unit 87 is configured to connect a selected one of the liquid supply lines 117 with a supply line 135, and to switch between different liquid supply lines 117. The supply line 135 is connected with an inlet of the fluid drive 20. Hence, solvent blending may be performed at the low-pressure side of the fluid drive 20 by metering or proportioning a sequence of fluidic portions.

A data processing unit or control unit 70, which can be a PC or workstation, may be coupled (as indicated by the dotted arrows) to one or more of the devices in the sample separation apparatus 10 in order to receive information and/or control operation. For example, the control unit 70 may control operation of the fluid drive 20 (for example setting control parameters) and receive therefrom information regarding the actual working conditions (such as output pressure, etc. at an outlet of the pump 20). The control unit 70 may also control operation of the solvent supply 25 (for example setting the solvent/s or solvent mixture to be supplied) and/or the degasser 27 (for example setting control parameters such as vacuum level) and may receive therefrom information regarding the actual working conditions (such as solvent composition supplied over time, vacuum level, etc.). The control unit 70 may further control operation of the sampling unit or injector 40 (for example controlling sample injection or synchronization of sample injection with operating conditions of the fluid drive 20). The separation unit 30 may also be controlled by the control unit 70 (for example selecting a specific flow path or column, setting operation temperature, etc.), and send-in return-information (for example operating conditions) to the control unit 70. Accordingly, the detector 50 may be controlled by the control unit 70 (for example with respect to spectral or wavelength settings, setting time constants, start/stop data acquisition), and send information (for example about the detected sample compounds) to the control unit 70. The control unit 70 may also control operation of the fractionating unit 60 (for example in conjunction with data received from the detector 50) and provides data back.

The already mentioned injector 40 of FIG. 1 is configured for injecting a fluidic sample into mobile phase delivered from fluid drive 20 to separation unit 30 along separation path 100. As shown, the injector 40 comprises an injector path 102 for accommodating fluidic sample to be injected using mobile phase. The fluidic valve 104 in the injector path 102 can be switched under control of control unit 70 for selectively fluidically coupling or decoupling the injector path 102 and the separation path 100. Furthermore, the injector 40 comprises a sample accommodation volume 106 in the injector path 102 for accommodating the fluidic sample to be injected into the separation path 100. The sample accommodation volume 106 can be embodied as a sample loop. A metering device 110 may suck a predefined amount of fluidic sample in the sample accommodation volume 106. Furthermore, a mixer 108 is arranged in the injector path 102 for mixing mobile phase, but not fluidic sample. Hence, controlled by control unit 70, switching of the fluidic valve 104 may be accomplished so that the mixer 108 is operated for mixing mobile phase without mixing the fluidic sample when the injector path 102 and the separation path 100 are fluidically coupled by the fluidic valve 104. Provision of the mixer 108 in the injector path 102 has the advantage that, when the separation unit 30 is purged, purging fluid (such as mobile phase) does not have to be conducted through the mixer 108. This may accelerate purging and may save purging fluid. In order to further promote quick purging with low amount of purging fluid, mixer 108′ in the separation path 100 can also be omitted in another embodiment.

FIG. 2 to FIG. 4 illustrate different operation states of an injector 40 according to an exemplary embodiment of the present disclosure.

The sample separation apparatus 10 corresponding to the injector 40 of FIG. 2 comprises a high-pressure pump as fluid drive 20 driving a mobile phase along a separation path 100. In a corresponding switching state of the fluidic valve 104, the fluid drive 20 drives the mobile phase through the fluidic valve 104 and towards the separation unit 30. Such an operation state is shown in FIG. 2.

A metering device 110 (such as a syringe pump) cooperates with fluidic valve 104, with sample accommodation volume 106 (here embodied as sample loop), with a needle 112 and with a seat 114. In the configuration according to FIG. 2, the needle 112 is located in a fluid-tight way in the seat 114. However, in order to aspirate or intake sample into the sample accommodation volume 106, the needle 112 may be driven out of the seat 114 (compare reference numeral 197) and may be immersed in liquid sample in a sample container 121. The piston of the metering device 110 may then move backwardly so as to aspirate sample from the sample container 121 via the needle 112 into the sample accommodation volume 106. Thereafter, the needle 112 may be driven back (for instance by a robot, not shown) into the seat 114 so as to establish again a fluid-tight connection.

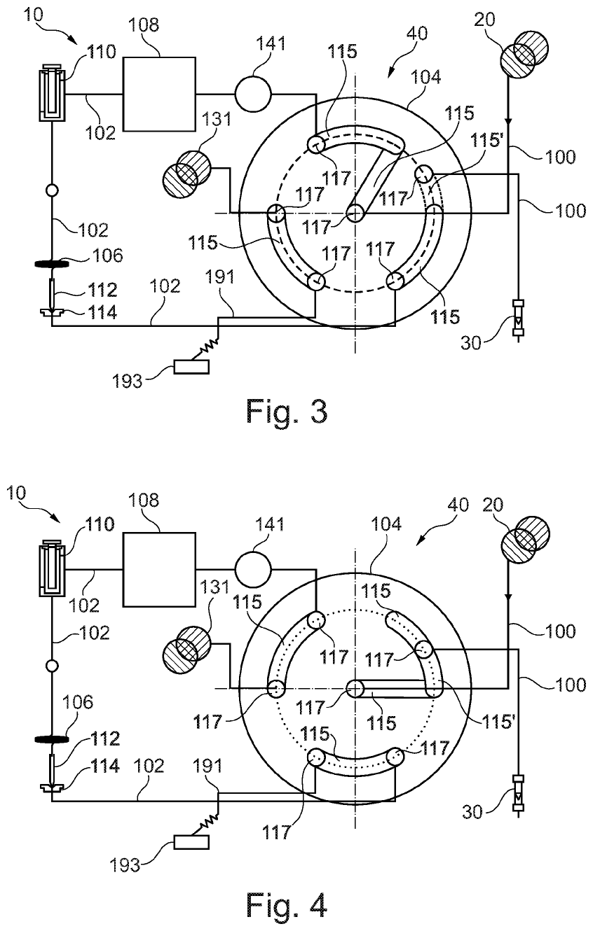

The fluidic sample in the sample accommodation volume 106 may then be injected into the separation path 100 between the fluid drive 20 and the separation unit 30 by switching fluidic valve 104 (see FIG. 3).

As shown in FIG. 2 as well, a flush pump 131 may be foreseen as well which may, in a corresponding switching state of the fluidic valve 104, flush conduits of the sample separation apparatus 10 according to FIG. 2. Fluid used for flushing or purging may be drained via a waste line 191 connected to fluidic valve 104. For flushing part of injector path 102, the fluidic valve 104 may be switched, starting from the configuration of FIG. 2, by 30° in clockwise direction (see FIG. 4). Rinse fluid may then flow from flush pump 131 through fluidic valve 104, a pressure sensor 141, a mixer 108, the metering device 110, sample accommodation volume 106, needle 112 and seat 114 and again through injection valve 104 and through waste line 191 into a waste container 193.

FIG. 2 shows that the injector 40 can be implemented with a single fluidic valve as fluidic valve 104. Alternatively, it is however possible that the fluidic valve 104 is composed of multiple fluidic valves. As taken from a cross-sectional view 195 of the fluidic valve 104 in FIG. 2, the fluidic valve 104 comprises a stator 113 with fluidic ports 117 to be connected to the various components of the sample separation apparatus 10 of FIG. 2. Furthermore, the fluidic valve 104 comprises a rotor 111 which is rotatable relative to the stator 113. Rotor 111 comprises one or more fluid conduits 115 (such as grooves) which can be brought into fluid alignment or out of fluid alignment with respective ones of the ports 117 by rotating rotor 111 relative to stator 113 so as to establish different fluid connection states. Optionally, also the stator 113 can comprise one or more fluid conduits 115′ (such as a stator groove).

Still referring to FIG. 2, the injector 40 comprises injector path 102 in which the fluidic valve 104, the sample accommodation volume 106, the metering device 110, the needle 112, the seat 114 as well as the pressure sensor 141 are arranged. Moreover, a mixer 108 is also implemented in the injector path 102, as explained below in further detail. In the valve switching state according to FIG. 2, the injector path 102 is fluidically decoupled with respect to the separation path 100. Consequently, a mobile phase may be driven by fluid drive 20 along the separation path 100 via the fluidic valve 104 up to separation unit 30. Independently therefrom, a fluidic connection in the injector path 102 is established from the fluidic valve 104, via the pressure sensor 141, the mixer 108, the metering device 110, the sample accommodation volume 106, the needle 112, and the seat 114, and back to the fluidic valve 104.

When driving the needle 112 out of the seat 114 and immersing the needle 112 into the sample container 121, driving the piston of the metering device 110 backwardly will aspirate fluidic sample through the needle 112 into the sample accommodation volume 106 at atmospheric pressure. Advantageously, fluidic sample does not get into contact with the mixer 108 during the process of loading fluidic sample into the sample accommodation volume 106. Thereafter, needle 112 may be driven back into the seat 114. The piston of the metering device 110 may then be driven forwardly for pre-compressing the fluidic sample in the sample accommodation volume 106. Hence, control unit 70 may control the metering device 110 for pre-compressing fluidic sample in sample accommodation volume 106 of the injector path 102 before injecting the fluidic sample from the injector path 102 into the separation path 100. By pre-compression, the fluidic sample in the sample accommodation volume 106 may be brought up to or close to system pressure (for example 1200 bar) in the high-pressure separation path 100. This may prevent excessive pressure strokes when subsequently switching into a separation mode. While fluidic sample is loaded and pre-compressed into the injector path 102, the separation unit 30 in the separation path 100 may be supplied with mobile phase from fluid drive 20. Furthermore, pre-compression in the separated injector path 102 may reduce a pressure dip upon subsequently injecting the loaded fluidic sample into the separation path 100.

According to FIG. 3, the fluidic valve 104 has been switched into a main pass mode in which the previously loaded fluidic sample is injected from the sample accommodation volume 106 into the separation path 100 for separation by separation unit 30. Fluid drive 20 (which may also be denoted as analytical pump) drives mobile phase from separation path 100 through fluidic valve 104, pressure sensor 141, mixer 108, metering device 110, sample accommodation volume 106, needle 112, and seat 114 in injector path 102, and back through fluidic valve 104 and into the separation path 100 to separation unit 30. While flowing along the mentioned flow path, the mobile phase transports the fluidic sample from sample accommodation volume 106 into separation unit 30 where the fluidic sample is chromatographically separated. During the described injection process, mobile phase from fluid drive 20 will flow through mixer 108 and may thereby be mixed for improving homogeneity of the solvent composition of the mobile phase. However, no fluidic sample will be brought in contact with the mixer 108 during injection, since the fluidic sample is located in the sample accommodation volume 106 and thereby downstream of the mixer 108 in the injection flow direction.

According to FIG. 4, the fluidic valve 104 has been further switched into a purge mode. In the purge mode, fluid drive 20 pumps mobile phase along separation path 100, through fluidic valve 104 and through separation unit 30. Consequently, separation unit 30 may be reconditioned and purged with mobile phase supplied by fluid drive 20. Advantageously, the separation unit 30 may be purged in separation path 100 without purging the mixer 108 in the separation path 100. This may reduce the volume of needed purging solvent and may reduce the purging time in separation path 100. At the same time, it is possible that the flush pump 131 purges the injector path 102 by pumping mobile phase through fluidic valve 104, pressure sensor 141, mixer 108, metering device 110, sample accommodation volume 106, needle 112, and seat 114, and back through fluidic valve 104 into the waste line 191 and finally into the waste container 193. Hence, fluid drive 20 functions as a purging device for purging the separation path 100 including the separation unit 30 with a purging fluid without purging the mixer 108 with the purging fluid. Moreover, flush pump 131 functions as a purging device for purging the injector path 102 including the mixer 108 with a further purging fluid.

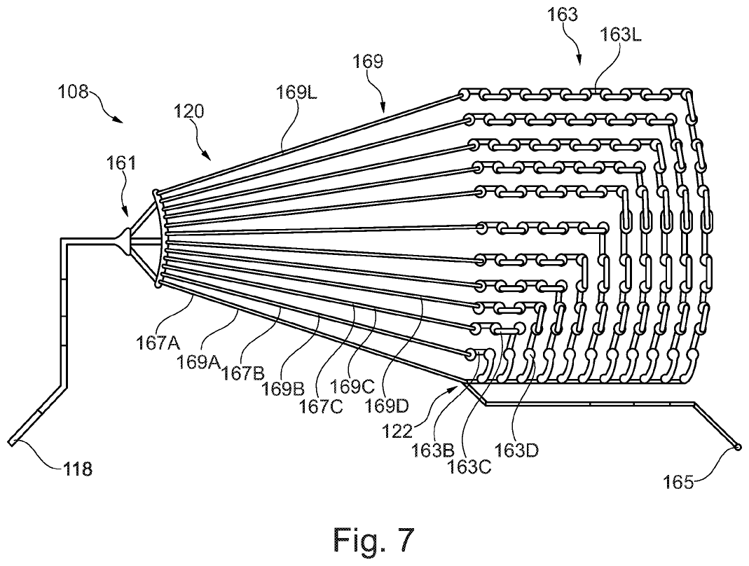

As mentioned above, the illustrated mixer 108 in the injector path 102 advantageously serves for mixing the mobile phase during injection without mixing the fluidic sample when the injector path 102 and the separation path 100 are fluidically coupled by the fluidic valve 104 according to FIG. 3. For instance, the mixer 108 may be a passive mixer (and may be embodied as shown in FIG. 7) or an active mixer for mixing the mobile phase for at least partially smoothing composition instabilities of the mobile phase. Referring to FIG. 2 and FIG. 3, the fluidic valve 104 is switchable under control of control unit 70 so that fluidic sample does not flow through the mixer 108 neither during intaking fluidic sample into the sample accommodation volume 106 nor during injecting fluidic sample from the sample accommodation volume 106 into the separation path 100. Hence, the fluidic valve 104 may be switched under control of control unit 70 so that fluidic sample never gets into contact with the mixer 108. Advantageously, this may avoid the risk of carryover of fluidic sample between different separation runs. The shielding of the mixer 108 with regard to fluidic sample may be promoted by locating the mixer 108 in the injector path 102 between the metering device 110 and the fluidic valve 104, as shown. An alternative for arranging the mixer is a position between the sample accommodation volume 106 and the metering device 110, as indicated by reference sign 108″ in FIG. 2. By avoiding arranging the mixer 108 between the sample needle 112 and the sample accommodation volume 106, it may be avoided that fluidic sample flows through the mixer 108 during loading and injecting fluidic sample. Advantageously, the fluidic valve 104 used for injection control may be synergistically used for switching mixer 108 (which may have a considerable interior volume) out of the purging path of separation unit 30. Hence, reconditioning and purging separation unit 30 may be accelerated and may be carried out with a small amount of mobile phase without the need of an additional fluidic valve, since this function is supported as well by fluidic valve 104.

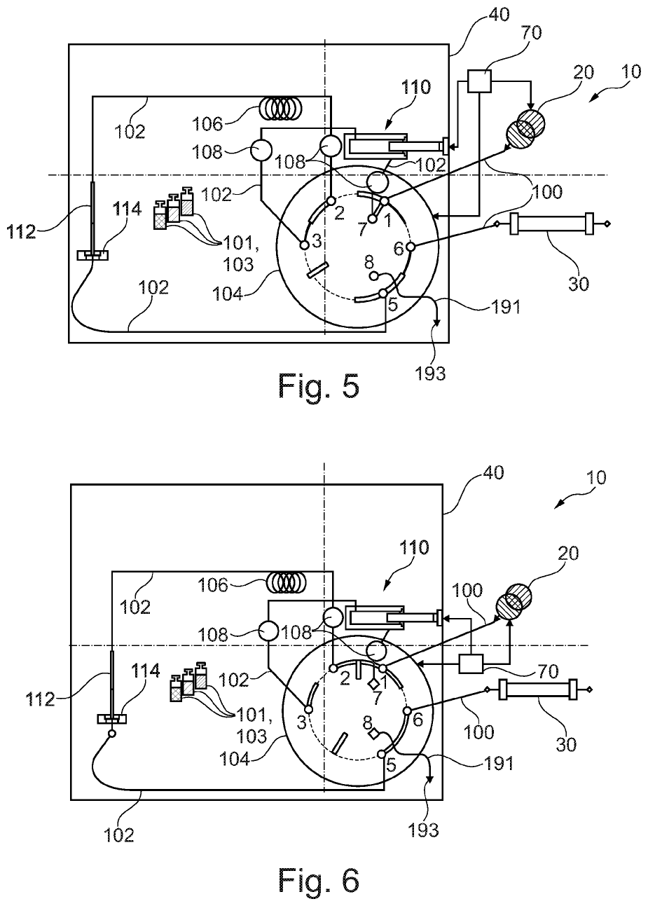

FIG. 5 and FIG. 6 illustrate an injector 40 according to another exemplary embodiment of the present disclosure. The sample injector 40 of FIG. 5 and FIG. 6 may operate within the sample separation apparatus 10 described above referring to FIG. 1. The sample injector 40 comprises many features which have already been described above referring to FIG. 1 to FIG. 4, to which reference is made for the sake of conciseness.

In FIG. 5 and FIG. 6, a port of fluidic valve 104 denoted as #1 is fluidically connected to fluid drive 20. A port of the fluidic valve 104 denoted as #2 is fluidically connected to sample accommodation volume 106 (or with a mixer 108). A port of the fluidic valve 104 denoted as #3 is fluidically connected to the outlet of the metering device 110 (or with a mixer 108). A port of the fluidic valve 104 denoted as #5 is fluidically connected to needle seat 114. A port of the fluidic valve 104 denoted as #6 is fluidically connected to separation unit 30. A port of the fluidic valve 104 denoted as #7 is fluidically connected to the inlet of the metering device 110 (or with a mixer 108). A port of the fluidic valve 104 denoted as #8 is fluidically connected to the waste line 191.

FIG. 5 and FIG. 6 illustrate three possible (additional or alternative) positions of one, two or three mixers 108 in injector path 102. In one alternative, mixer 108 is arranged between fluidic valve 104 and an inlet of metering device 110. In another alternative, mixer 108 is arranged between fluidic valve 104 and an outlet of metering device 110. In a further alternative, mixer 108 is arranged between fluidic valve 104 and sample accommodation volume 106.

In FIG. 5, an operation mode of injector 40 is shown in which both the metering device 110 and the mixer 108 (at all three possible positions) are switched into a flow path in which mobile phase flows from fluid drive 20 to separation unit 30 through separation path 100 and injector path 102.

In FIG. 6, another operation mode of injector 40 is shown (activated by switching fluidic valve 104) in which the metering device 110 is switched out of a flow path in which mobile phase flows from fluid drive 20 to separation unit 30 through separation path 100 and part of injector path 102. Furthermore, the mixer 108, in two of the three possible positions (i.e. when arranged between fluidic valve 104 and metering device 110), is switched out of the flow path in which mobile phase flows from fluid drive 20 to separation unit 30 through separation path 100 and part of injector path 102. In the third position of mixer 108 (when arranged between fluidic valve 104 and sample accommodation volume 106), mixer 108 remains inside flow path.

Hence, the fluidic valve 104 according to FIG. 5 and FIG. 6 is configured to be operable so that a mixer 108 can be switched out of a flow path along which mobile phase flows (see two configurations according to FIG. 6). Consequently, the fluidic valve 104 of FIG. 5 and FIG. 6 is configured to be operable so that the respective mixer 108 is bypassed with regard to a flow of mobile phase when the injector path 102 and the separation path 100 are fluidically coupled by the fluidic valve 104 (see the two configurations according to FIG. 6).

Moreover, the fluidic valve 104 according to FIG. 5 and FIG. 6 is configured to be operable so that the metering device 110 is bypassed with regard to a flow of mobile phase when the injector path 102 and the separation path 100 are fluidically coupled by the fluidic valve 104 (see all three mixer configurations according to FIG. 6).

More specifically, the fluidic valve 104 according to FIG. 5 and FIG. 6 is configured to be operable so that both a mixer 108 and the metering device 110 for intaking a metered amount of fluidic sample into the sample accommodation volume 106 are bypassed with regard to a flow of mobile phase when the injector path 102 and the separation path 100 are fluidically coupled by the fluidic valve 104 (see the two configurations according to FIG. 6).

However, in another switching state of fluidic valve 104 shown in FIG. 5, the mixer(s) 108 and the metering device 110 are within a flow path of mobile phase when the injector path 102 and the separation path 100 are fluidically coupled by the fluidic valve 104.

Thus, mixer 108 and/or metering device 110 may be selectively engaged into or disengaged from an active flow path. Thus, any of mixer(s) 108 and metering device 110 may also be included in or excluded from purging.

FIG. 7 illustrates a mixer 108 for an injector 40 according to an exemplary embodiment of the present disclosure. To put it shortly, FIG. 7 shows a passive mixer 108 adapted for splitting mobile phase supplied at a mixer inlet 118 into a plurality of fluid paths 120 with different internal fluid flow delay characteristics and adapted for combining the fluid paths 120 at one or a plurality of rejoining points 122 to thereby mix the mobile phase in a longitudinal fashion.

In the embodiment of FIG. 7, the mixer 108 comprises the inlet 118 receiving an inlet flow of the fluid to be mixed. A flow distributor 161 receives the flow from the inlet 118 and distributes it-fluidically in parallel-into a plurality of fluid paths 120. Accordingly, the flow distributor 161 provides a plurality of parallel partial flows into the plurality of (parallel) fluid paths 120.

The flow distributor 161 of FIG. 7 is designed so that it substantially simultaneously distributes the fluid into the fluid paths 120 and/or that a variation of the property of the fluid arrives substantially simultaneously at the first sections 169 of the fluid paths 120.

In the embodiment of FIG. 7, the flow distributor 161 comprises a multi-stage configuration that provides nearly simultaneous arrival of parts of a given partial fluid volume to all the restrictor channels in combination with low distributor volume. Other embodiments are also possible in order to achieve lowest total volume of the distributor.

The plurality of fluid paths 120 may couple to a flow combiner at rejoining point 122, which combines the partial flows from the plurality of fluid paths 120 and provides them to an outlet flow. The outlet flow is output by an outlet 165. The flow combiner may be designed to provide a minimum volume, as such volume of the flow combiner or rejoining point 122 typically contributes mainly to delay and less to mixing properties.

Each of the plurality of fluid paths 120 comprises a first flow section 169, and some of the fluid paths 120 further comprise a second flow section 163 coupled in series to the respective first flow section 169. In the embodiment of FIG. 7, a first flow channel 167A comprises (only) a first flow section 169A coupling directly between the flow distributor 161 and the flow combiner. A second flow channel 167B comprises a first flow section 169B coupling to a second flow section 163B, which then also couples into the flow combiner. Accordingly, a third flow channel 167C comprises a first flow section 169C coupling into a second flow section 163C, which then couples to the flow combiner. This continues accordingly for further flow channels. In FIG. 7, further first flow sections 169D-169L and second flow sections 163D-163L are shown, each coupling in series and to the flow combiner.

The first flow sections 169A-169L are designed to provide a significantly larger hydraulic resistance than the respective second flow sections 163B-163L, so that the total hydraulic resistance of each flow channel 167 is dominated by the hydraulic resistance of the respective first flow section 169. Further in the specific embodiment of FIG. 7, all of the first flow sections 169A-169L are designed to have substantially the same length and cross section, so that each first flow section 169 substantially has the same hydraulic resistance. Considering that the hydraulic resistance of each flow channel 167 is dominated by its respective first flow section 169, it can be assumed that each flow channel 167 can be regarded as providing substantially the same hydraulic resistance to the fluid when introduced into the fluid paths 120 at the flow distributor 161. When designing the flow distributor 161 to distribute the inlet flow substantially evenly into the fluid paths 120, it can be assumed that the partial flow in each flow channel is substantially equal. The distribution of the partial flows into the fluid paths 120 in such embodiment is substantially independent of the viscosity of the fluid because any viscosity change arrives to the first sections 167A-L simultaneously and the distribution ratio of the partial flows is thus maintained constant independently of the viscosity of the provided solvent.

While the hydraulic resistance of each flow channel 167 is dominated by its respective first flow section 169, each second flow section 163 has a volume delaying fluid propagation (from the respective first section 169 to the flow combiner) by a time required by the respective partial flow to pass the volume of the respective second flow section 163. In each flow channel 167, the volume of the second flow section 163 is designed to be significantly larger than a volume of the respective first flow section 169. In such an embodiment, the propagation time of each partial flow will be mainly influenced by the volume of the respective second flow section 163. By providing different volumes of the respective second flow sections 163, a (desired) flow characteristic can be obtained. By having at least one flow channel 167 without a second flow section 163, the total resulting flow characteristic of the mixer 108 can be designed to have the minimum delay as resulting from the first flow section 169 only.

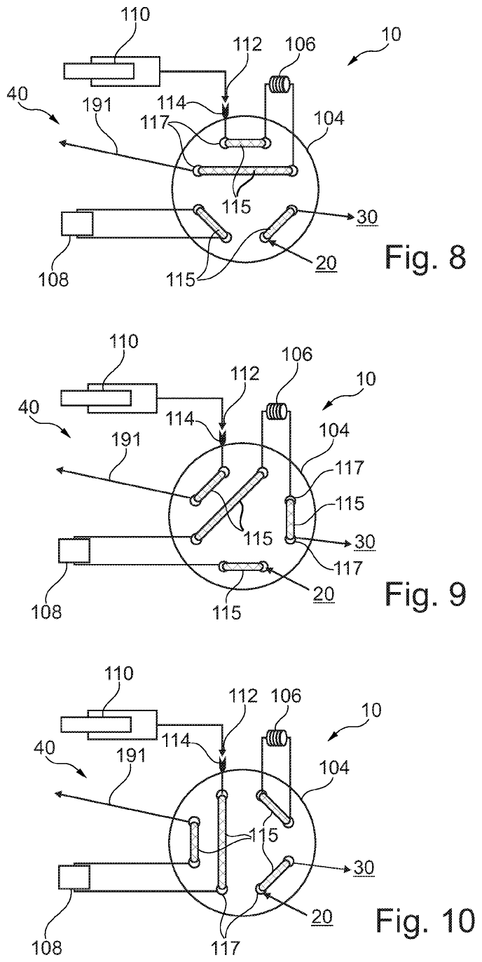

FIG. 8 to FIG. 10 illustrate different operation states of an injector 40 according to still another exemplary embodiment of the present disclosure with a sampling accommodation volume 106 embodied as fixed loop.

Referring to FIG. 8, the fixed loop injector 40 is shown in a switching state of fluidic valve 104 in which fluidic sample is loaded in or into the sampling accommodation volume 106 while mixer 108 is bypassed.

Referring to FIG. 9, the fixed loop injector 40 is shown in another switching state of fluidic valve 104 in which fluidic sample is injected towards sample separation unit 30, while mobile phase, but no fluidic sample, flows through mixer 108.

Referring to FIG. 10, the fixed loop injector 40 is shown in yet another switching state of fluidic valve 104 in which mixer 108 is bypassed.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

1. An injector for injecting a fluidic sample from an injector path into a mobile phase for separation of the fluidic sample in a separation path of a sample separation apparatus, the injector comprising:
the injector path configured to accommodate the mobile phase and the fluidic sample;
a fluidic valve configured to be switchable for selectively fluidically coupling or decoupling the injector path and the separation path;
a sample accommodation volume in the injector path and configured to accommodate the fluidic sample to be injected into the separation path; and
a mixer in the injector path and configured to mix the mobile phase without mixing the fluidic sample when the injector path and the separation path are fluidically coupled by the fluidic valve.

2. The injector according to claim 1, wherein the injector is configured to be operable so that the fluidic sample does not flow through the mixer either during intaking the fluidic sample into the sample accommodation volume or during injecting the fluidic sample from the sample accommodation volume into the separation path.

3. The injector according to claim 1, comprising at least one of the following features:
wherein the injector is configured to be operable so that the fluidic sample never gets into contact with the mixer;
wherein the mixer is arranged between the sample accommodation volume and the fluidic valve.

4. The injector according to claim 1, comprising a metering device configured to intake a metered amount of the fluidic sample in the sample accommodation volume.

5. The injector according to claim 4, wherein the metering device is arranged in the injector path between the sample accommodation volume and the mixer.

6. The injector according to claim 4, wherein the mixer is arranged between the metering device and the fluidic valve.

7. The injector according to claim 4, comprising a control unit configured to control the metering device for pre-compressing at least part of the injector path before injecting the fluidic sample from the injector path into the separation path.

8. The injector according to claim 1, comprising a sample needle and a needle seat, wherein the sample needle is movable out of the needle seat for intaking the fluidic sample through the sample needle and into the sample accommodation volume, and wherein the sample needle is movable into the needle seat for injecting the in-taken fluidic sample into the separation path by switching the fluidic valve.

9. The injector according to claim 8, wherein the mixer is arranged apart from a section between the sample needle and the sample accommodation volume.

10. The injector according to claim 1, wherein the fluidic valve is configured to be operable so that the mixer is switched out of a flow path along which the mobile phase flows.

11. The injector according to claim 1, wherein the fluidic valve is configured to be operable so that the mixer is bypassed with regard to a flow of the mobile phase when the injector path and the separation path are fluidically coupled by the fluidic valve.

12. The injector according to claim 1, wherein the fluidic valve is configured to be operable so that a metering device configured to intake a metered amount of the fluidic sample into the sample accommodation volume is bypassed with regard to a flow of the mobile phase when the injector path and the separation path are fluidically coupled by the fluidic valve.

13. The injector according to claim 1, wherein the fluidic valve is configured to be operable so that the mixer and a metering device configured to intake a metered amount of the fluidic sample into the sample accommodation volume are bypassed with regard to a flow of the mobile phase when the injector path and the separation path are fluidically coupled by the fluidic valve.

14. The injector according to claim 1, wherein the mixer is a passive mixer or an active mixer.

15. The injector according to claim 1, wherein the mixer is configured to split the mobile phase supplied at a mixer inlet into a plurality of fluid paths with different internal fluid flow delay characteristics, and is configured to combine the fluid paths at one or a plurality of rejoining points to thereby mix the mobile phase in a longitudinal fashion.

16. The injector according to claim 1, wherein the mixer is configured to mix the mobile phase for at least partially smoothing composition instabilities of the mobile phase.

17. The injector according to claim 1, comprising at least one of the following features:
the injector comprises a purging device configured to purge at least part of the separation path with a purging fluid without purging the mixer with the purging fluid;
the injector comprises a purging device configured to purge at least part of the separation path with a purging fluid without purging the mixer with the purging fluid, wherein the purging device comprises a fluid drive configured to drive the mobile phase;
the injector comprises a purging device configured to purge a separation unit in the separation path with a purging fluid without purging the mixer with the purging fluid;
wherein the fluidic valve is arranged in the injector path.

18. A sample separation apparatus for separating a fluidic sample, the sample separation apparatus comprising:
a fluid drive configured to drive a mobile phase and the fluidic sample, when injected in the mobile phase, along a separation path;
the injector according to claim 1 configured to inject the fluidic sample into the separation path; and
a separation unit configured to separate the fluidic sample injected in the mobile phase in the separation path.

19. The separation apparatus according to claim 18, further comprising at least one of the following features:
the sample separation apparatus comprises a further mixer arranged upstream of the injector in the separation path and upstream or downstream of the fluid drive;
the sample separation apparatus is configured as a chromatography sample separation apparatus;
the sample separation apparatus comprises a detector configured to detect separated fractions of the fluidic sample;
the sample separation apparatus comprises a fractionating unit configured to collect separated fractions of the fluidic sample;
the sample separation apparatus comprises a degassing apparatus configured to degas the mobile phase.

20. A method of injecting a fluidic sample from an injector path of an injector into a mobile phase for separation of the fluidic sample in a separation path of a sample separation apparatus, the method comprising:
accommodating the fluidic sample to be injected into the separation path in a sample accommodation volume in the injector path;
switching a fluidic valve for selectively fluidically coupling the injector path and the separation path; and
mixing the mobile phase without mixing the fluidic sample by a mixer in the injector path when the injector path and the separation path are fluidically coupled by the fluidic valve.
